(19) United States
(12) Patent Application Publication
(10) Pub. No.: US 2011/0101578 A1
(43) Pub. Date: May 5, 2011

(54) AIR SUSPENSION

(75) Inventor: Young Chun JI, Gyeonggi-do (KR)

(73) Assignee: MANDO CORPORATION

(21) Appl. No.: 12/913,369

(22) Filed: Oct. 27, 2010

(30) Foreign Application Priority Data
Nov. 2, 2009 (KR) 10-2009-0104873

(51) Int. Cl. B60G 15/12; F16F 9/16; F16F 9/06

(52) U.S. Cl. 267/64.15

(57) ABSTRACT

Disclosed is an improved air suspension that prevents damage and/or failure of a component of an air spring, such as an air sleeve. The air suspension includes a damper including a cylinder and a piston rod slidably disposed in the cylinder, an air spring hermetically connected to an outside of the cylinder, an upper mount which secures the damper and the air spring to a vehicle frame, and a rotational sealing part disposed between the air piston and the cylinder and allowing relative rotation of the air spring and the cylinder while maintaining air-tightness between the air piston and the cylinder. The air suspension may prevent damage and/or failure of components of an air spring, such as an air sleeve, by undesired force or moment such as torsional rotational force applied to the air spring in the course of driving the vehicle.

### CROSS REFERENCE TO RELATED APPLICATION

This application claims priority from and the benefit of Korean Patent Application No. 10-2009-0104873, filed on Nov. 2, 2009, which is hereby incorporated by reference for all purposes as if fully set forth herein.

### BACKGROUND

1. Technical Field

The present disclosure relates to an air suspension including a damper and an air spring, and, more particularly, to an air suspension which includes an improved structure to prevent damage of a component of an air spring, in particular, an air sleeve.

2. Description of the Related Art

In general, a suspension is disposed between a vehicle frame and wheels, and includes springs and dampers, that is, shock absorbers. A suspension system employing air springs is referred to as an “air suspension”. The air suspension includes an upper mount for securing both the damper and air spring to the vehicle frame.

The damper includes a cylinder and a piston rod. The cylinder has a space filled with an operating fluid, such as oil, inside a tube. A piston valve is disposed in the tube to generate damping force in cooperation with the operating fluid. Since the piston valve is connected to a piston rod, the piston valve generates the damping force in cooperation with the operating fluid by relative movement between the cylinder and the piston rod.

The air spring includes a canister, an air piston, and an air sleeve. The canister is hermetically joined to the air piston by the air sleeve, which is made of a flexible material. Accordingly, the air piston and the canister can move relative to each other and the air sleeve is resiliently operated with respect to relative movement between the air piston and the canister by compressed air in the air spring.

Generally, the upper mount secures the piston rod of the damper and the canister of the air spring to a vehicle frame side. Here, the air piston of the air spring is secured to a lower portion of the damper.

Conventionally, the air suspension has a problem in that components of the air spring, in particular, an air sleeve and/or an air tube, are highly susceptible to damage due to vertical movement, torsional rotation and upward tilt (that is, coning angle) applied to the air spring during steering.

This problem is common to both canister insert-molded integration type and canister/upper mount separation type air suspensions.

In the former case, for example, when steering a 5-link double wishbone type vehicle, the variation in kingpin axis causes the up-down movement, torsional rotation and coning angle of the air spring, resulting in the formation of cracks in the damper bush or damaging the air sleeve. In the latter case, when steering the 5-link double wishbone type vehicle, the variation in kingpin inclination causes the up-down movement, torsional rotation and coning angle in the air spring, so that torsional moment is generated between the upper mount and the canister, thereby damaging the air tube.

Conventionally, a bush for the upper mount is made of a soft material, or a smooth connection is provided to an upper portion of the air sleeve in order to prevent the air sleeve or air tube from being damaged due to torsional rotation applied to the air spring. However, such a configuration does not sufficiently prevent damage and/or failure of the components of the air spring due to application of repeated torsional rotation to the air spring.

### BRIEF SUMMARY

The present disclosure is directed to solving the problems of the related art, and an aspect of the present disclosure provides an improved air suspension that prevents damage and/or failure of components of an air spring, such as an air sleeve, by undesired force or moment such as torsional rotation force applied to the air spring in the course of driving the vehicle.

In accordance with an aspect of the present disclosure, an air suspension includes: a damper including a cylinder and a piston rod slidably disposed in the cylinder; an air spring hermetically connected to an outside of the cylinder; an upper mount which secures the damper and the air spring to a vehicle frame; and a rotational sealing part disposed between the air piston and the cylinder and allowing relative rotation of the air spring and the cylinder while maintaining air-tightness between the air piston and the cylinder.

The air spring may include a canister surrounding a part of the piston rod extending outside the cylinder and an air piston surrounding a part of the cylinder; an air sleeve hermitically connecting the canister and the air piston. The rotational sealing part may be inserted between the air piston and the cylinder.

A bearing may be disposed between the bracket for connecting the air suspension to an axle or wheel side and the cylinder to allow relative rotation between the bracket and the cylinder.

### BRIEF DESCRIPTION OF THE DRAWINGS

FIG. 1 is a side-sectional view of an air suspension in accordance with an exemplary embodiment of the present disclosure;

FIG. 2 is an enlarged view of part “A” of FIG. 1; and

FIG. 3 is an enlarged view of part “B” of FIG. 1.

### DETAILED DESCRIPTION

Hereinafter, exemplary embodiments of the present disclosure will be described in detail with reference to the accompanying drawings. Like elements will be denoted by like reference numerals throughout the specification and drawings.

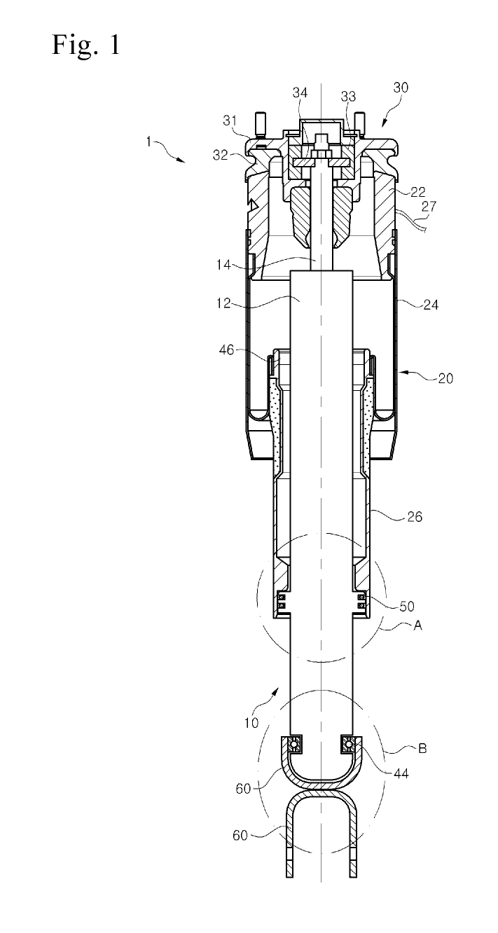

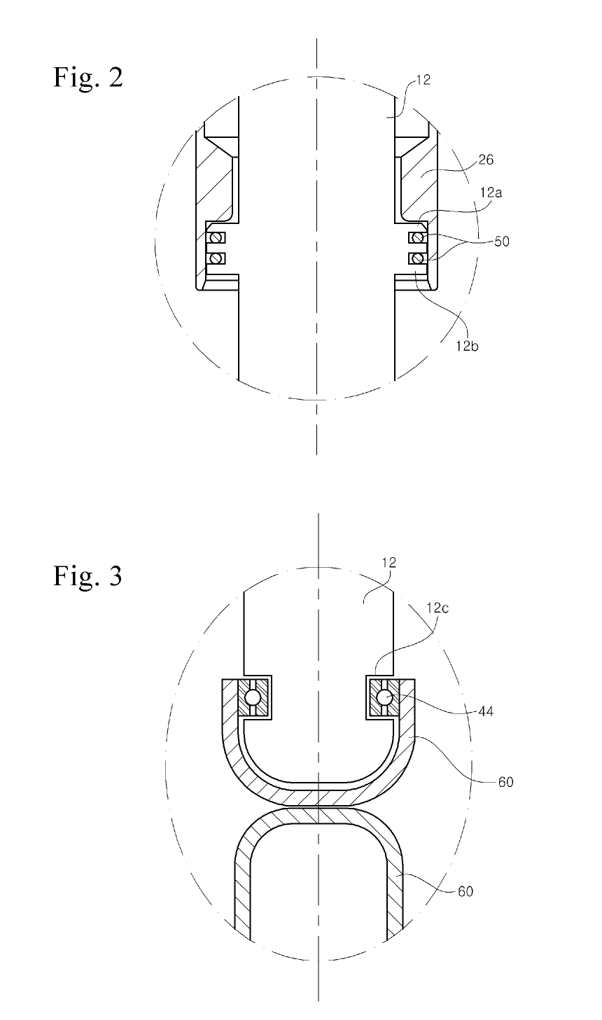

FIG. 1 is a side-sectional view of an air suspension in accordance with an exemplary embodiment, FIG. 2 is an enlarged view of part “A” of FIG. 1, and FIG. 3 is an enlarged view of part “B” of FIG. 1.

Referring to FIG. 1, an air suspension 1 according to this embodiment includes a damper 10, an air spring 20 mounted on the damper 10, and an upper mount 30 for connecting the damper 10 and air spring 20 to a vehicle frame (not shown). The damper 10 is provided at a lower side thereof with a bracket 60 which connects the air suspension to an axle or wheel side.

The damper 10 includes a cylinder 12 and a piston rod 14. Although not shown in the drawings, an elongated space filled with an oil is defined in the cylinder 12 and a piston valve (not shown) connected to the piston rod 14 is slidably received in this space. The piston valve reciprocates inside the cylinder 12 by relative movement between the piston rod 14 connected to a vehicle frame side and the cylinder 12 connected to a wheel side, thereby generating a certain damping force in cooperation with the oil.

The air spring 20 includes a canister 22, an air sleeve 24, and an air piton 26. The canister 22 surrounds a part of the piston rod 14 extending outside the cylinder 12 and the air piston 26 surrounds a part of the cylinder 12. The canister 22 and the air piston 26 are hermetically connected to each other by the air sleeve 24, so that an air compartment filled with compressed air is formed in the air spring 20. The canister 22 is connected to an air tube 27, which is also connected to the air compartment inside the air spring 20.

The upper mount 30 is mounted on the canister 22 to connect the damper 10 and air spring 20 to the vehicle frame side. The upper mount 30 may include a mount bracket 31, a first mount bush 32, a second mount bush 33, and a rod holder 34. The upper mount 30 is connected to the canister 22 via the first mount bush 32.

The mount bracket 31 is coupled at an upper portion thereof to the vehicle frame by bolts and nuts and has a depressed portion at a center of the mount bracket 31, through which the piston rod 14 passes, so that the second mount bush 33 and the rod holder 34 supported by the second mount bush 33 are placed on the depressed portion. Obviously, the upper mount 30 may be modified in a variety of ways and the upper mount 30 is not limited to the details shown in the drawing.

In this embodiment, a rotational sealing part 50 is disposed between a lower end of the air piston 26 and the cylinder 12. The rotational sealing part 50 serves to allow relative rotation between the damper 10 and the air spring 20 with respect to torsional rotation applied to the air spring 20 while maintaining air-tightness between the air piston 26 and the cylinder 12. Components, such as the rotational sealing part, which are used to seal a rotational part, are well known in the art, and a detailed description thereof will be omitted herein.

FIG. 2 is an enlarged view of the rotational sealing part 50. The rotational sealing part 50 is inserted into a groove between first and second projections 12a, 12b on an outer surface of the cylinder 12 to maintain air-tightness between the air piston 26 and the cylinder 12 while allowing relative rotation therebetween. The rotational sealing part 50 may be modified in a variety of ways so long as such modification maintains air-tightness between the air piston 26 and the cylinder 12 while allowing relative rotation therebetween.

In this embodiment, a bearing 44 is provided between the bracket 60 for connecting the air suspension to the axle or wheel side and the cylinder 12 of the damper 10. The bearing 44 enables relative rotation between the bracket 60 and the cylinder 12.

FIG. 3 is an enlarged view of the bearing 44. The bearing 44 may be supported at one or both ends thereof by a step 12c formed on the cylinder 12. The bearing 44 may be a thrust ball bearing to provide effective support with respect to an axial load applied to the cylinder 12. Those skilled in the art will appreciate that the bearing 44 may take various forms so long as relative rotation between the bracket 60 and the cylinder 12 is possible while supporting the axial load applied to the cylinder 12.

In this embodiment, the rotational sealing part 50 allows relative rotation between the cylinder 12 of the damper 10 and the air piston 26 of the air spring 20. Further, the bearing 44 enables the relative rotation between the cylinder 12 of the damper 10 and the bracket 60 for connecting the air suspension to the axle or wheel side. As such, by providing one or both of the rotational sealing part 50 and the bracket 44 to the air suspension, it is possible to effectively prevent the components of the air spring, particularly, the air sleeve and/or air tube from being damaged due to torsional rotation applied to the air spring in the course of driving.

As such, according to the embodiments, the air suspension may prevent damage and/or failure of components of an air spring, such as an air sleeve, by undesired force or moment such as torsional rotation force applied to the air spring in the course of driving the vehicle.

The various embodiments described above can be combined to provide further embodiments. Aspects of the embodiments can be modified, as necessary, to employ concepts of the various patents, applications and publications to provide yet further embodiments. These and other changes can be made to the embodiments in light of the above-detailed description. In general, in the following claims, the terms used should not be construed as limiting the claims to the specific embodiments disclosed in the specification and the claims, but should be construed to include all possible embodiments along with the full scope of equivalents to which such claims are entitled. Accordingly, the claims are not limited by the disclosure.

1. An air suspension comprising:
a damper including a cylinder and a piston rod slidably disposed in the cylinder;
an air spring hermetically connected to an outside of the cylinder;
an upper mount which secures the damper and the air spring to a vehicle frame; and
a rotational sealing part disposed between the air piston and the cylinder and allowing relative rotation of the air spring and the cylinder while maintaining air-tightness between the air piston and the cylinder.

2. The air suspension of claim 1, wherein the air spring comprises a canister surrounding a part of the piston rod extending outside the cylinder, an air piston surrounding a part of the cylinder, and an air sleeve hermitically connecting the canister and the air piston, and wherein the rotational sealing part is inserted between the air piston and the cylinder.

3. The air suspension of claim 1, wherein a bearing is disposed between the bracket for connecting the air suspension to an axle or wheel side and the cylinder to allow relative rotation between the bracket and the cylinder.
